(19) United States
(12) Patent Application Publication
(10) Pub. No.: US 2014/0313366 A1
(43) Pub. Date: Oct. 23, 2014

(54) METHOD OF PROCESSING IMAGE AND ELECTRONIC DEVICE AND SYSTEM SUPPORTING THE SAME

(71) Applicant: Samsung Electronics Co., Ltd., Suwon-si (KR)

(72) Inventors: Yongman LEE, Seongnam-si (KR); Kwangyoung KIM, Suwon-si (KR); Sungdae CHO, Yongin-si (KR)

(73) Assignee: Samsung Electronics Co., Ltd., Suwon-si (KR)

(21) Appl. No.: 14/242,184

(22) Filed: Apr. 1, 2014

(30) Foreign Application Priority Data
Apr. 19, 2013 (KR) 10-2013-0043853

(51) Int. Cl. H04N 5/232

(52) U.S. Cl. CPC H04N 5/23229; H04N 5/23293
USPC 348/222.1

(57) ABSTRACT

An image processing method, and an electronic device and a system supporting the same are provided. The method includes obtaining a first image by using an image sensor, generating a second image compatible with an output device from the first image based on mapping information, and outputting the second image to the output device.

### CROSS-REFERENCE TO RELATED APPLICATION(S)

This application claims the benefit under 35 U.S.C. §119(a) of a Korean patent application filed on Apr. 19, 2013 in the Korean Intellectual Property Office and assigned Serial number 10-2013-0043853, the entire disclosure of which is hereby incorporated by reference.

### TECHNICAL FIELD

The present disclosure relates to image processing. More particularly, the present disclosure relates to image processing of an image sensor.

### BACKGROUND

Electronic devices have a communication function and are used by many people due to their portability. The electronic devices have dramatically grown on the strength of the development of hardware and software which may provide various contents and main functions of the electronic device are an image obtaining function and an image providing function.

Accordingly, an image processing method capable of performing improved image processing, and an electronic device and a system supporting the same is desired.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an image processing method capable of performing improved image processing, and an electronic device and a system supporting the same.

In accordance with an aspect of the present disclosure, a method of processing an image by an electronic device is provided. The method includes obtaining a first image by using an image sensor, generating a second image compatible with an output device from the first image based on mapping information, and outputting the second image to the output device.

In accordance with another aspect of the present disclosure, an electronic device is provided. The electronic device includes an image sensor configured to obtain a first image, a storage unit configured to store at least one mapping information, a display unit configured to selectively output a second image generated from the first image according to a control, and a controller configured to generate the second image from the first image based on the mapping information, and to output the second image to the display unit.

In accordance with another aspect of the present disclosure, an electronic device is provided. The electronic device includes an image obtaining module configured to obtain a first image by using an image sensor, a generation module configured to generate a second image compatible with an output device from the first image based on mapping information, and an output module configured to output the second image to the output device.

As described above, according to the image processing method, and the electronic device and the system supporting the same according to the present disclosure, the present disclosure may provide various effects by reducing calculation load and improving image processing in an operation supporting a preview mode.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 schematically illustrates a configuration of an electronic device supporting image processing according to an embodiment of the present disclosure;

FIG. 2 is a block diagram illustrating a configuration of a controller of FIG. 1 in more detail according to an embodiment of the present disclosure;

FIG. 3 is a view describing image processing for a preview mode according to an embodiment of the present disclosure;

FIG. 4 is a flowchart illustrating an electronic device operating method in a preview mode of an image processing method according to an embodiment of the present disclosure;

FIG. 5 is a block diagram schematically illustrating a configuration of an image processing system supporting image processing according to an embodiment of the present disclosure; and

FIG. 6 is a flowchart describing an electronic device control method in a system supporting a preview mode of an image processing method according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein may be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

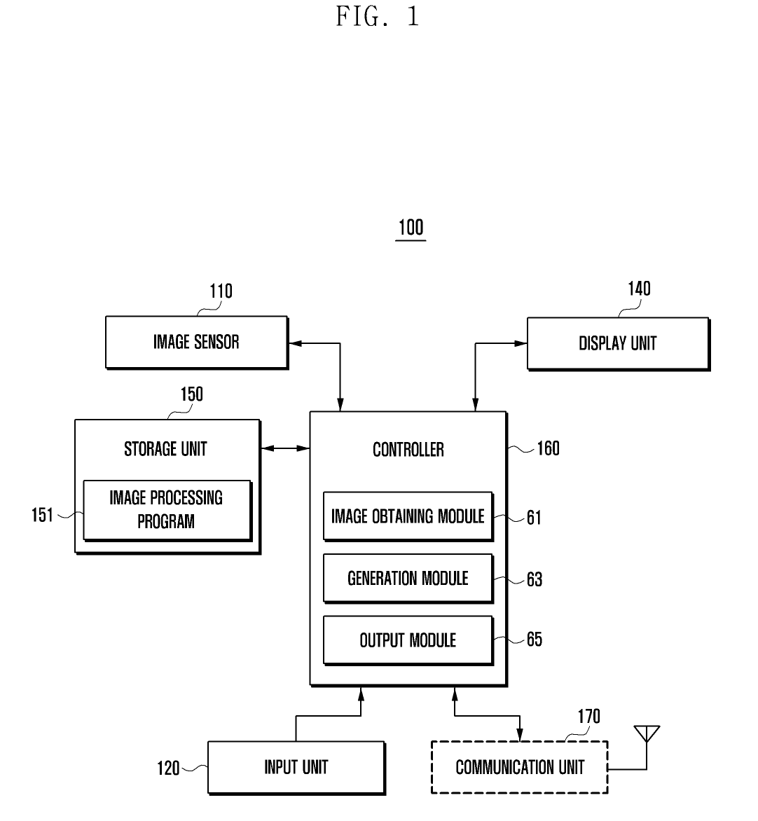

FIG. 1 schematically illustrates a configuration of an electronic device supporting image processing, for example, a terminal according to an embodiment of the present disclosure.

Referring to FIG. 1, a terminal 100 according to the present disclosure may include an image sensor 110, an input unit 120, a display unit 140, a storage unit 150, and a controller 160, but is not limited thereto. The display unit 140 may be a component such as an output device for outputting an image of the electronic device. The terminal 100 may further include a communication unit 170 including at least one communication module which may support at least one communication function of a short-distance communication function and a mobile communication function. The terminal may further include a component such as an audio processor which may output at least one signal of a transmitted/received audio signal, a stored audio signal, and a collected audio signal.

The terminal 100 including the above components may generate a preview image of an image obtained by the image sensor 110 by controlling a scale based on mapping information that is optionally predefined. Further, the terminal 100 may output the generated preview image on the display unit 140. In such an operation, the terminal 100 according to the present disclosure may convert a sensor image in a Red, Green, and Blue (RGB) type provided by the image sensor 110 to a preview image in the same RGB type. The image sensor 110 may obtain an image having various resolutions according to a hardware characteristic. For example, when hardware of the image sensor 110 obtains an image of 8 Mega Pixel (MP) resolution, the controller 160 may generate a preview image of 2 MP resolution by controlling a scale. In such an operation, the controller 160 may perform an image conversion based on mapping information to convert a sensor image to a proper preview image. The mapping information used at this time may be configured in various forms according to a resolution of the display unit 140 or a hardware characteristic of the display unit 140.

The image sensor 110 is a device which obtains and collects an image. In the image sensor 110, a plurality of semiconductor devices may be disposed in a matrix form. A resolution of the image sensor 110 may be determined according to degree of integration of the plurality of semiconductor devices disposed in the matrix form. The image sensor 110 applied to the terminal 100 according to the present disclosure may be a device which may obtain and collect an image of a relatively higher resolution in comparison with an image output on the display unit 140. The image sensor 110 may include components such as a lens module, a housing surrounding the lens module, and an optical conversion circuit which processes light input through the lens module to convert the light to data of a particular type, but is not limited thereto. The image sensor 110 may provide an image of a subject of a particular type, for example, an image of an RGB type to the controller 160. Alternatively, the image 110 may provide an image of a subject of a Red, Green, Blue, and White (RGBW) type to the controller 160 according to a design type. Hereinafter, a preview image processing function according to the present disclosure will be described with an example of the RGB type.

The input unit 120 is a component supporting generation of various input signals related to an operation of the terminal 100. The input unit 120 may include at least one hardware key (not illustrated) or physical key (not illustrated) prepared in at least one side of the terminal 100. The input unit may generate an input signal for turning on or off the terminal 100, an input signal for turning on or off the display unit 140, an input signal for activating the image sensor 110, and an input signal for capturing an image. A particular key of the physical key of the input unit 120 may be designed as a hot key which may directly activate the image sensor 110.

Further, the input unit 120 may generate an input signal for activating a preview function of the image sensor 110 and an optical condition controlling signal of the image sensor 110 according to a user's control. When the terminal 100 supports the preview function by default when the image sensor 110 is activated, an input signal generating function for activating the preview function may be omitted. The optical condition controlling signal may include a signal for controlling at least one function of the image sensor 110. For example, the optical condition controlling signal may include a distance control signal such as digital zoom-in or zoom-out, a flash application signal, an image effect control signal, a shutter speed control signal, an ISO control signal, one shot or burst shot control signal and the like. The generated input signal is transmitted to the controller 160. When the display unit 140 is implemented in an input means form such as a touch screen, the display unit 140 may be understood as a component such as the input unit 120 in terms of generation of the input signal. The display unit 140 in a touch screen type may generate the various input signals as touch events based on a touch and transmit the touch events to the controller 160.

The display unit 140 may output various screens related to the operation of the terminal 100. For example, the display unit 140 may output a menu screen, a widget screen, an icon screen, an idle screen, a gallery screen, and a web access screen required for the operation of the terminal 100, but is not limited thereto. Particularly, the display unit 140 may provide a screen including an icon or a menu item for activating the image sensor 110. Further, the display unit 140 may output a preview image corresponding to a sensor image provided by the image sensor 110 according to a preview function request. The preview image output on the display unit 140 may be an image generated by controlling a scale of the sensor image.

The display unit 140 may be limited to a predetermined size or smaller (for example, in a case where the terminal 100 is prepared to support a portable function). A resolution of the display unit 140 of the terminal 100 may vary depending on a size of a hardware integration technology. For example, the resolution of the display unit 140 may be 960×640, 1280×800, or 800×480. Accordingly, when a high resolution sensor image obtained by the image sensor 110 is output on the display unit 140, a scale of the image may be controlled and displayed. An up scaling or a down scaling may be applied to the image output on the display unit 140. Hereinafter, the down scaling will be described as a main example.

The display unit 140 may have one of various types. The display unit may be one of various display devices, such as a liquid crystal display type, an AMOLED type, a Plasma Display Panel (PDP), a FET panel, a carbon nanotube based panel and the like. Further, the display unit 140 may have different types of output images according to the above types. For example, the display unit 140 may have image display types such as an RGBW color filter type, an RGBG AMOLED type, and an RGBW LCD type according to a distinction scheme of reading four pixels in zigzags. Further, the display unit 140 may be an RGB AMOLED type in which three successive subpixels are arranged in the RGB type.

The storage unit 150 is a component for storing various programs and data required for the operation of the terminal 100. For example, the storage unit 150 may include at least one Operating System (OS) for the operation of the terminal 100. The storage unit 150 may include various programs for supporting functions of the terminal 100, for example, a browser application (hereinafter referred to as an “app”), a music play app, a video reproduction app, a broadcast reception app, a black box function app, a video chatting app, a video call app and the like. Further, the storage unit 150 may include an image processing program 151 to support a preview image processing function according to the present disclosure.

The image processing program 151 may include a preview image generating routine corresponding to a sensor image obtained and provided by the image sensor 110. The preview image generating routine may include at least one of a sensor image pre-processing routine, a mapping routine converting the pre-processed image based on mapping information that is optionally predefined, and a routine post-processing the converted image to generate a preview image. Each of the routines may be loaded to the controller 160 when the image sensor 110 is operated and support an output of the preview image through a function corresponding to the routine. The routines may be mounted to the controller 160 in an embedded type or a middleware type without being stored in the storage unit 150 or mounted to a separate hardware module in an embedded type or a middleware type and then provided. Roles of the routines and data processing will be described in more detailed together with a description of a configuration of the controller 160 below.

The terminal 200 according to the present disclosure may include a component such as the communication unit 170 including at least one communication module to support a communication function. The communication unit 170 may have a form of, for example, a mobile communication module. The communication unit 170 may support reception of mapping information. The mapping information may be reference information applied to an operation for switching the sensor image to the preview image. The mapping information may be updated according to various experimental results and statistical results. Accordingly, the communication unit 170 may support a communication channel formation with a service device providing the mapping information. The terminal 100 may receive the mapping information provided by the communication unit 170 and store the mapping information in the storage unit 150. Alternatively, when the terminal 100 is designed to store the mapping information in the controller 160, the terminal 100 may update the mapping information recorded in the controller 160 into new mapping information received by the communication unit 170. When the terminal 100 does not support the communication function, the configuration of the communication unit 170 may be omitted. In the terminal 100 which does not have the communication unit 170, the mapping information may be pre-stored in an operation of manufacturing the terminal. Further, the mapping information may be stored in a separate memory chip and transmitted to the terminal 100.

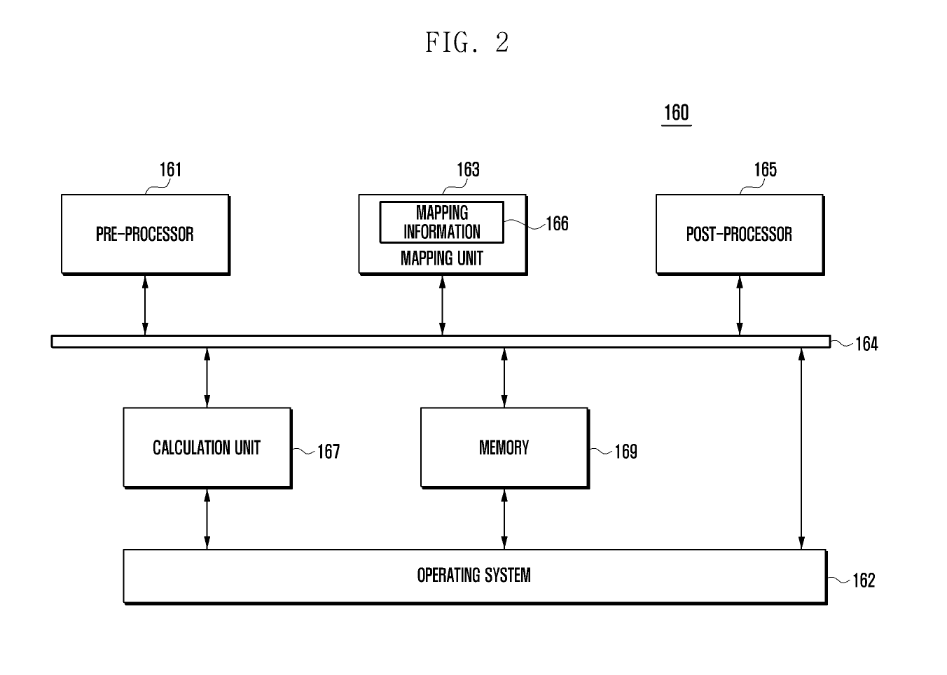

The controller 160 may process various data required for the operation of the functions of the terminal 100, process signals, transmit a control signal, activate an app, and control the input unit 120 and the display unit 140. Particularly, the controller 160 may include at least one of an image obtaining module 61, a generation module 63, and an output module 65 for supporting the preview image processing function according to the present disclosure, but is not limited thereto. The controller 160 having the above components may support at least one of an operation of obtaining and processing a first image from the image sensor, an operation of generating and processing a second image compatible with an output device, for example, the display unit 140 from the obtained first image based on mapping information that is optionally predefined, and an operation of outputting and processing the generated second image. The controller 160 may include a configuration as illustrated in FIG. 2.

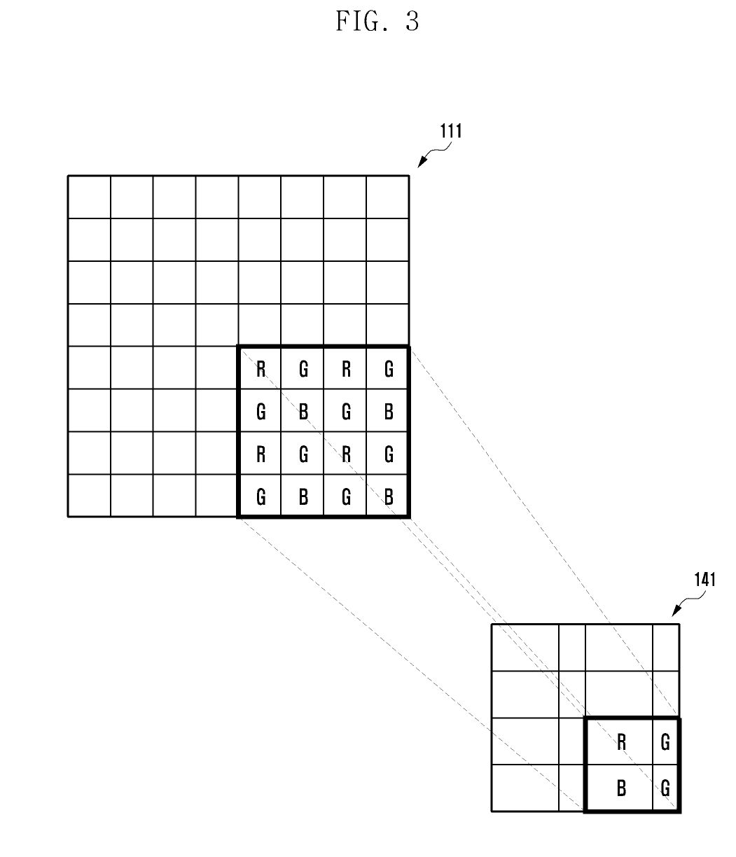

FIG. 2 illustrates the configuration of the controller 160 of the terminal 100 according to an embodiment of the present disclosure and FIG. 3 is a view describing an example of image mapping of a mapping unit 163 of the controller 160 according to an embodiment of the present disclosure.

Referring to FIG. 2, the controller 160 according to the present disclosure may include a pre-processor 161, a mapping unit 163, and a post-processor 165. Further, the controller 160 may include a calculation unit 167, a memory 169, an operating system 162, and a bus 164 to support image processing of the above described components, but is not limited thereto.

The pre-processor 161 may support controlling of the image sensor 110. For example, the pre-processor 161 may control the image sensor 110 according to an input signal related to the image sensor 110 generated by at least one of the input unit 120 and the display unit 140. For example, the pre-processor 161 may control a focus of the image sensor 110. Further, the pre-processor 161 may control brightness of the image sensor 110. The pre-processor 161 may correct the sensor image provided by the image sensor 110. For example, the pre-processor 161 may perform lens shading, defect correction, Auto Exposure (AE), Auto White Balance (AWB), and Auto Focusing (AF) control. The pre-processor 161 may pre-process the sensor image provided by the image sensor 110 and transmit the sensor image to the mapping unit 163. The pre-processor 161 may transmit the sensor image remaining in the RGB type to the mapping unit 163.

The mapping unit 163 may support a pattern conversion according to a resolution conversion or a digital zoom. The mapping unit 163 may convert a sensor image of a particular type provided by the pre-processor 161, for example, a sensor image of the RGB type according to a hardware characteristic of the display unit 140. For example, the mapping unit 163 may perform a scale control, for example, up scaling or down scaling on a raw Bayer pattern of the sensor image in accordance with a Bayer pattern of the display unit 140. The mapping unit 163 may control the Bayer pattern of the sensor image in accordance with the Bayer pattern of the display unit 140 based on pre-stored mapping information 166.

The mapping information 166 may be stored in the storage unit 150 and referred to thereafter. Alternatively, the mapping information 166 may be recorded in the mapping unit 163 and referred to thereafter. The mapping information 166 may include information defining how to change the pattern when changing the sensor Bayer pattern to the Bayer pattern of the display unit. FIG. 3 is a view describing an example of applying the mapping information 166. For example, the mapping information 166 shows a change from four pixels (corresponding to sixteen subpixels based on four subpixels) of a sensor Bayer pattern 111, in which four subpixels are arranged in an “RGGB” pattern, to pixels of one display unit Bayer pattern 141 as illustrated in FIG. 3. In the display unit Bayer pattern 141, four subpixels may be arranged in the “RGBG” pattern. In the display unit Bayer pattern 141, physical sizes of the respective subpixels may be defined as different sizes.

For example, the mapping information 166 illustrated in FIG. 3 may be information defined to generate a preview image generated by down scaling a resolution of the sensor image by ¼. When the RGGB pattern corresponding to the sensor Bayer pattern 111 is changed to an RGBG pattern corresponding to the display unit Bayer pattern 141, various schemes may be defined according to an experimental result. In the RGB type, colors of the pixel may be differently defined according to a physical characteristic of hardware. For example, when 8 bits are applied for the physical characteristic of hardware to distinguish image colors, respective subpixels may have 256 colors in the RGB type. Accordingly, the mapping information 166 may be information of changing a plurality of subpixel colors of the sensor Bayer pattern 111 to one subpixel color of the display unit Bayer pattern 141.

For example, the mapping information 166 may define an average of colors of “R” elements included in 16 subpixels of the sensor Bayer pattern 111 as a color value of an “R” subpixel of the display unit Bayer pattern 141. Similarly, the mapping information 166 may define an average of colors of “B” elements included in 16 subpixels of the sensor Bayer pattern 111 as a color value of a “B” subpixel of the display unit Bayer pattern 141. Further, the mapping information 166 may define an average of colors of “G” elements included in 32 subpixels of the sensor Bayer pattern 111 as a color value of two “G” subpixels of the display unit Bayer pattern 141. Alternatively, the mapping information 166 may define highest color values of the color values of “R”, “B”, and “B” elements included in 16 subpixels of the sensor Bayer pattern 111 as color values of “R”, “G”, and “B” subpixels of the display unit Bayer pattern 141.

Further, the mapping information 166 may define a nonlinear pattern conversion. For example, the mapping information 166 may define such that the pattern conversion is differently applied according to a characteristic of each area of the collected image. For example, the mapping information 166 may define a pattern conversion in a boundary area of the sensor image as a first type pattern conversion and a pattern conversion in a non-boundary area in which a color is not changed as a second type pattern conversion.

As one example, the first type pattern conversion may be a scheme supporting such that the boundary area is displayed more clearly, for example, a scheme of assigning a higher weight to a value having a higher color. Further, as an example, the second type pattern conversion may be a scheme of applying a “white” weight to more clearly distinguish color brightness of the non-boundary area. The scheme of applying the “white” weight may be applied when the image sensor 110 provides an RGBW Bayer pattern. Alternatively, when only an RGB Bayer pattern is applied, a whiter value calculating scheme and a weight applying scheme according to the whiter value calculating scheme implemented by the RGGB pixel may be defined.

As described above, the mapping information 166 according to the present disclosure may be defined in at least one of various types during an operation of converting the sensor Bayer pattern to the display unit Bayer pattern. Accordingly, the embodiment of the present disclosure is not limited to the definition scheme of the mapping information 166. For example, since the mapping information 166 may be variously changed according to a hardware characteristic of the image sensor 110 and a hardware characteristic of the display unit 140, the mapping information 166 may be variously defined according to an experimental and statistical results based on a characteristic of the electronic device to which the present disclosure is applied.

Referring back to FIG. 2, the post-processor 165 may process such that the image, of which the pattern is controlled, transmitted by the mapping unit 163 becomes a proper preview image to be output on the display unit 140. For example, the post-processor 165 may update picture quality information to be finally output on the display unit 140. The post-processor 165 may perform color image processing and display processing. The color image processing may include operations, such as noise reduction, color correction and the like. The display processing may include operations such as flip/rotate processing, smooth/sharpness processing, crop processing and the like.

The calculation unit 167 is a component for controlling and adjusting tasks of the pre-processor 161, the mapping unit 163, and the post-processor 165. For example, the tasks may be performed using various routines provided by the operating system 162. In such an operation, the calculation unit 167 may refer to schedule information of various routines required for driving the image sensor 110 and support a setup control of the image sensor 110 based on the schedule information. Further, the calculation unit 167 may activate the image sensor 110 according to an input signal input from the input unit 120 and the display unit 140 and provide the sensor image obtained by the image sensor 110 to the pre-processor 161. In addition, the calculation unit 167 may control the image sensor 110 through the pre-processor 161 according to the set schedule information. Particularly, the calculation unit 167 according to the present disclosure may convert the sensor image to the preview image based on the mapping information 166 under a control of the mapping unit 163. During such an operation, the calculation unit 167 may convert the sensor Bayer pattern to the display unit Bayer pattern according to information recorded in the mapping information 166. Further, when a digital zoom-in or zoom-out input signal is generated, the calculation unit 167 may additionally control the display unit Bayer pattern conversion according to the corresponding input signal.

The memory 169 may be an area to which data is loaded for operations of the controller 160. The memory 169 may be provided as a separate device or chip distinguished from the storage unit 150 or may be a part of the storage unit 150. For example, when the storage unit 150 is manufactured in a flash memory type of the terminal 100 or provided in a hard disc form, the memory 169 may be provided in a Random Access Memory (RAM) type. The memory 169 may serve as a work space supporting performance of the pattern mapping in an operation supporting a preview image processing function according to the present disclosure. Although the memory 169 may be provided in the RAM type or a cache type in terms of approachableness or speed, the present disclosure is not limited thereto. The memory 169 may store the sensor image having the sensor Bayer pattern and may be an area storing a preview image having the display unit Bayer pattern converted from the sensor Bayer pattern.

The bus 164 may be a physical and/or logical component supporting transmission of data the above described components and transmission of a control signal. In the present disclosure, the bus 164 may carry out transmission of the sensor image obtained by the image sensor 110 to the memory 169. Further, the bus 164 may carry out transmission of a control signal controlling such that the mapping unit 163 converts the sensor image to the display unit Bayer pattern. In addition, the bus 164 may transmit data stored in the memory 169 to the post-processor 165 and support data transmission to output a preview image generated by the post-processing on the display unit 140.

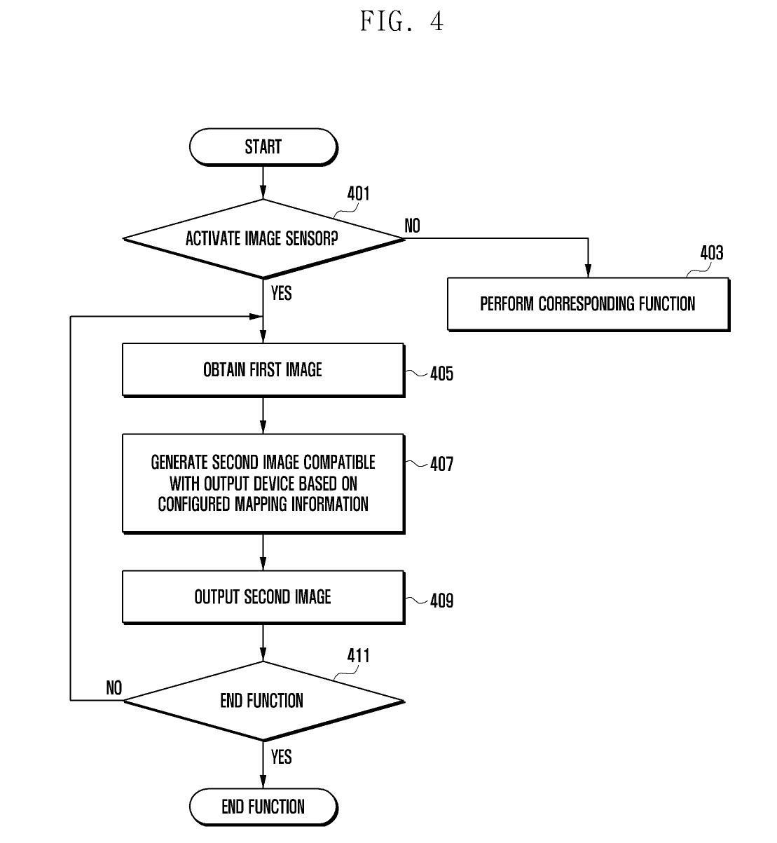

FIG. 4 is a flowchart illustrating a method of controlling the electronic device to support a preview mode of an image processing method according to an embodiment of the present disclosure.

Referring to FIG. 4, in the method of controlling the electronic device to process the preview image according to the present disclosure, the controller 160 of the terminal 100 may first receive an event generated by preset schedule information or an event input from the input unit 120 or the display unit 140. For example, the controller 160 may receive an input signal making a request for collecting an image by a key input of the input unit 120 or receive an input signal as a touch event. The controller 160 may identify whether the received event is an event for activating a preview mode of the image sensor 110 in operation 401. When the event received in the operation is an event irrelevant to the image sensor 110, the controller 160 may support performance of a function according to the corresponding event in operation 403. For example, the controller 160 may receive performance of a function according to an event characteristic, such as a voice call function, a data communication function, a broadcast reception function, a message function, a file reproduction function, a file editing function, a gallery function or the like.

When the event generated in operation 401 is related to the operation of the image sensor 110, the controller 160 may activate the image sensor 110 and obtain a first image, for example, the sensor image to support the preview mode in operation 405. In the operation, the controller 160 may control power supply of the image sensor 110 and an environment of the image sensor 110 according to a predefined sensor setup. Particularly, when the controller 160 is configured to support the preview image by default when the image sensor 110 is activated, the controller 160 may support the preview mode by default.

According to an embodiment of the present disclosure, when the activated image sensor 110 obtains and provides a sensor image of a subject, the controller 160 may generate a second image compatible with an output device based on configured mapping information in operation 407. For example, the controller 160 may generate a preview image of the first image compatible with the display unit 140 based on the mapping information. The mapping information may be predefined. For example, the controller 160 may convert a sensor image in the sensor Bayer pattern provided by the image sensor 110 to the display unit Bayer pattern by the mapping information 166. Further, the controller 160 may output the image converted to the display unit Bayer pattern on the display unit 140 as the second image, for example, preview image. The controller 160 may perform a pre-processing operation for the sensor image while performing the above operation. Further, the controller 160 may perform a post-processing operation for the image converted to the display unit Bayer pattern. The pre-processing operation and the post-processing operation correct image errors of the sensor image and the preview image or process such that the sensor image and the preview image are more sharply or clearly displayed.

The controller 160 may identify whether an event for terminating the function is generated in operation 411. When a separate event for terminating the function is not generated, the process returns to an operation before operation 405 and controls to re-perform the following operations.

As described above, the controller 160 may generate and output the preview image having the Bayer pattern in the same type as that of the sensor Bayer pattern. Accordingly, the controller 160 according to the present disclosure may not perform at least one operation of extracting a characteristic of the sensor image, converting a type of the extracted characteristic, processing a signal of the converted type, and re-converting a type of the signal-processed image. As a result, the controller 160 may generate the preview image from the sensor image based on a simpler image processing scheme and output the generated preview image.

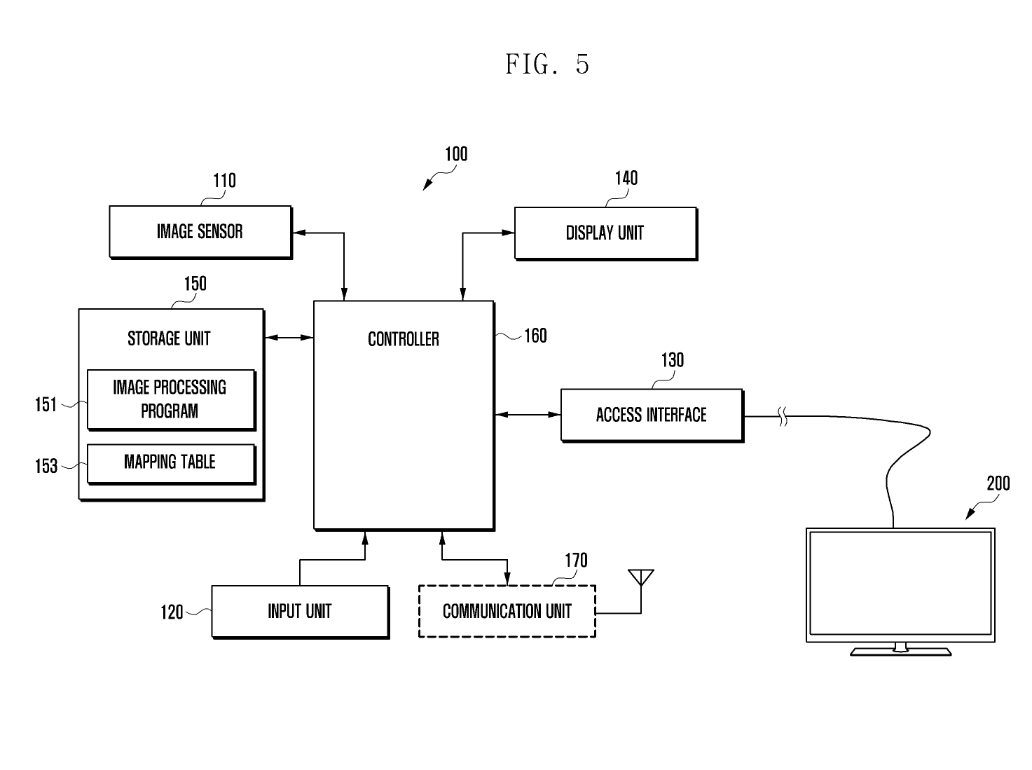

FIG. 5 is a block diagram schematically illustrating a configuration of an image processing system supporting an image processing function according to an embodiment of the present disclosure.

Referring to FIG. 5, an image processing system 10 according to the present disclosure may include the electronic device, for example, the terminal 100 and a configuration of an external display device 200 connected to the terminal 100, but is not limited thereto. The image processing system 10 may include a display unit 140 of the terminal 100 and the external display device 200 as output devices for outputting an image.

In the image processing system 10, the terminal 100 may be connected to the external display device 200 through an access interface 130 included in the terminal 100. The image processing system 10 having the above configuration may generate an external output preview image to be output to the external display device 200 from the sensor image obtained by the image sensor 110. The image processing system 10 according to the present disclosure may identify a display characteristic of the external display device 200 and select mapping information corresponding to the display characteristic. Further, the image processing system 10 may support such that an external output preview image is generated from the sensor image based on the selected mapping information and the generated external output preview image is output on the external display device 200. As a result, the image processing system 10 may support the output of an optimal external output preview image by using mapping information optimized for the external display device 200 among various mapping pieces of information.

According to an embodiment of the present disclosure, the terminal 100 may include an image sensor 110, an input unit 120, an access interface 130, a display unit 140, a storage unit 150, and a controller 160 as illustrated in FIG. 5, but is not limited thereto. The terminal 100 may further include a communication unit 170. Such a configuration may support at least a part of functions similar to those of the components described in FIG. 1. Accordingly, in the following description, a more detailed description of a function part for processing the preview image in the image processing system 10 according to the present disclosure will be made.

According to an embodiment of the present disclosure, the image sensor 110 may be activated according to a control of the controller 160 to collect a sensor image of a sensor Bayer pattern of a subject. Further, the sensor image 110 may provide a sensor image to the controller 160. The image sensor 110 may collect and provide a sensor image in a particular Bayer pattern, such as an RGB type or an RGBW type according to the scheme designed as described above.

According to an embodiment of the present disclosure, the input unit 120 may generate an input signal for activating the image sensor 110 and an input signal for activating a preview mode according to the present disclosure. Further, the input unit 120 may generate various input signals related to a control of the terminal 100. Particularly, when the terminal 100 is connected to the external display device 200 through the access interface 130, the input unit 120 may generate a particular mapping information selection signal for supporting the external display device 200. When the access interface 130 is connected to the external display device 200, the controller 160 may identify a type of the external display device 200 and automatically select mapping information according to the type. However, in a case of a particular external display device 200, automatic selection of optimal mapping information may be provided. In this event, the controller 160 may provide a screen for selecting mapping information for providing the external output preview image to the external display device 200. The user may manually select particular mapping information by using the input unit 120, and/or the display unit 140 having an input function.

According to an embodiment of the present disclosure, the access interface 130 may support the connection of the external display device 200. For example, the access interface 130 may include a wired access interface for supporting a wired connection with the external display device 200 through a cable. Further, the access interface 130 may include a wireless access interface for wirelessly transmitting data to the external display device 200. Accordingly, the access interface 130 may be prepared in a form of a short-range communication module as well as a serial interface such as a USB or a UART. When the external display device 200 is connected to the access interface 130, the access interface 130 may transmit a signal according to the connection of the external display device 200 to the controller 160.

According to an embodiment of the present disclosure, the display unit 140 may output various screens related to the operation of the terminal 100. The display unit 140 may output a menu screen or an icon screen for selecting an activation of the image sensor 110. Further, the display unit 140 may output a control screen for an environment setup of the image sensor 110 when the image sensor 110 is activated. The display unit 140 may output the generated preview image by applying first mapping information from the sensor image obtained by the image sensor 110. The first mapping information may be mapping information for optimizing the sensor image for the display unit Bayer pattern. The display unit 140 may be automatically turned off when the external display device 200 is connected to the access interface 130. Alternatively, the display unit 140 may maintain a turned on state independently from the connection of the external display device 200 or may be turned off according to schedule information or a control of the user.

According to an embodiment of the present disclosure, the storage unit 150 may store a program and data required for the operation of the terminal 100. Particularly, the storage unit 150 may store the aforementioned image processing program 151. Further, the storage unit 150 may include a mapping table 153 including a plurality of pieces of mapping information to output preview images on a plurality of display devices. Compared with the image processing program 151 described through FIG. 1, the image processing program 151 described through FIG. 5 may further include a routine supporting generation and output of an external output preview image to be output on the external display device 200 connected through the access interface 151. For example, the image processing program 151 may include a display unit output routine supporting the preview image output through the display unit 140 and an external display device output routine supporting processing the external output preview image through the external display device 200. The display unit output routine may include the routines of the image processing program 151 described in FIG. 1. The external display device output routine may include a routine identifying a connection of the external display device 200 in a preview mode and a routine identifying a type of the external display device 200. Further, the external display device output routine may include a second mapping information selection routine for generating the external output preview image to be output on the external display device 200, a routine generating the external output preview image based on second mapping information, and a routine outputting the generated external output preview image.

According to an embodiment of the present disclosure, the controller 160 may control generation and output of the external output preview image according to the connection between the access interface 130 and the external display device 200 when the preview mode of the image sensor 110 is supported. More specifically, when the external display device 200 is connected to the access interface 130, the controller may identify a type of the external display device 200, for example, device ID information. Alternatively, the controller 160 may identify a Bayer pattern which the external display device 200 has. Further, the controller 160 may search for mapping information corresponding to device ID information or Bayer pattern information in the mapping table 153. The mapping information stored in the mapping table 153 may be stored for each of the ID information or each of the Bayer pattern information. The mapping information may include a mapping algorithm for generating an optimized external output preview image in accordance with a hardware characteristic of the display unit 140 or the external display device 200 from the sensor image.

According to an embodiment of the present disclosure, the controller 160 may select mapping information suitable for the external display device 200 and generate the external output preview image from the sensor image based on the selected mapping information. Further, the controller 160 may support such that the generated external output preview image is output on the external display device 200 through the access interface 130. Accordingly, the external display device 200 may output the external output preview image generated from the sensor image obtained by the image sensor 110.

According to an embodiment of the present disclosure, the controller 160 may receive a request for outputting the preview image on the display unit 140 independently from the external display device 200. In this event, the controller 160 may generate the preview image from the sensor image based on first mapping information for supporting the preview image of the display unit 140. Further, the controller 160 may output the generated preview image on the display unit 140. Accordingly, the controller 160 may simultaneously output the preview image on the display unit 140 and the external display device 200 according to schedule information or an input request. Alternatively, the controller 160 may output the preview image on one of the display unit 140 and the external display device 200 according to generation of an event.

According to an embodiment of the present disclosure, the communication unit 170 is a component supporting a communication function of the terminal 100. The communication unit 170 may update the mapping table 153 or search for mapping information. For example, the communication unit 170 may receive mapping information from an external server device (not illustrated) according to a predetermined period or a particular event. The mapping information received by the communication unit 170 may be transmitted to the controller 160 and the controller 160 may update the mapping table 153 stored in the storage unit 150 by using the received mapping information. Further, the communication unit 170 may search for mapping information optimized for a device ID or a Bayer pattern provided by the external display device 200. The communication unit 170 may establish a communication channel with an external server device providing mapping information automatically or according to a user's request. Further, the communication unit 170 may provide the device ID or Bayer pattern information to an external server device according to a control of the controller 160. When the external server device provides mapping information corresponding to the corresponding device ID or Bayer pattern information, the communication unit 170 may receive the mapping information and provide the mapping information to the controller 160. Accordingly, the controller 160 may search for, in real time, and apply mapping information optimized for the external display device 200 connected through the access interface 130.

According to an embodiment of the present disclosure, the external display device 200 may be a device which may be connected to the terminal 100 through the access interface 130. The external display device 200 may establish a communication channel with the terminal 100 through at least one of wired and wireless schemes. Further, the external display device 200 may receive the preview image from the terminal 100 through the established communication channel and output the preview image. The external display device 200 may provide device ID information and Bayer pattern information of the display device to the terminal 100 through the access interface 130. Further, the external display device 200 may receive an external output preview image optimized for the information provided by the external display device and output the external output preview image in real time. The external display device 200 may be an electronic device having a display panel, for example, a TeleVision (TV) monitor, a smart TV, a tablet Personal Computer (PC), a slate PC, a pad type or note type PC or the like.

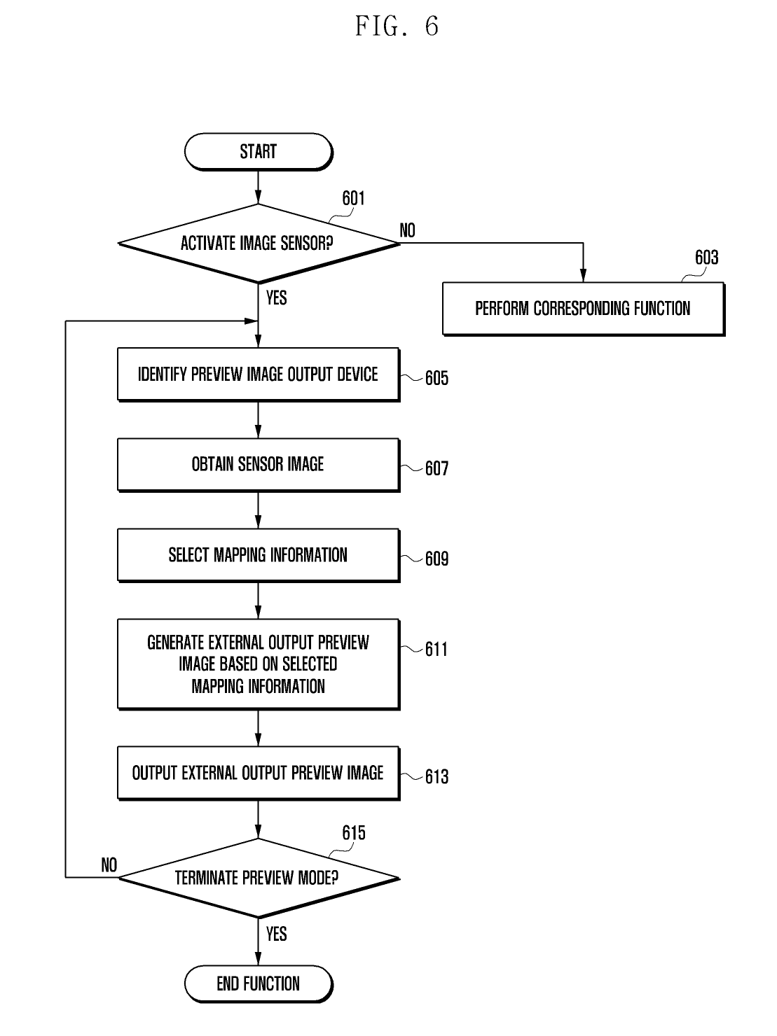

FIG. 6 is a flowchart illustrating a method of controlling the electronic device in the system supporting the preview mode of an image processing method according to an embodiment of the present disclosure.

Referring to FIG. 6, in the method of controlling the electronic device in the system supporting the preview mode according to the present disclosure, the controller 160 of the terminal 100 may first receive a particular event according to schedule information or an input event generated by an input means of the input unit 120 or the display unit 140. The controller 160 may identify whether the received event is an event for activating the preview mode of the image sensor 110 in operation 601.

When the received event is irrelevant to the preview mode, the controller 160 may support performance of a function of the terminal 100 according to a type and characteristic of the corresponding event. For example, the controller 160 may support a picture editing function, a background image changing function, a file reproduction function, a communication function and the like.

When a request for supporting the preview mode is made in operation 601, the controller 160 may identify a device to output the preview image in operation 605. For example, the controller 160 may identify whether the external display device 200 is connected to the access interface 130. Further, the controller 160 may identify reception of an event for outputting the external output preview image on the connected external display device 200. If it is designed to output the external output preview image by default when the external display device 200 is connected to the access interface 130, an operation of identifying the reception of the event may be omitted. In the following operation, a description will be made based on a state where the external display device 200 is connected to the access interface 130 and a request for outputting the external output preview image on the corresponding external display device 200 is made.

According to an embodiment of the present disclosure, when the request for outputting the external output preview image on the external display device 200 is made, the controller 160 may obtain the sensor image in operation 607. Further, the controller 160 may select mapping information to convert the sensor image to the external output preview image to be output on the external display device 200 in operation 609. The controller 160 may search for matching mapping information in the mapping table 153 based on identification information of the external display device 200. An operation of obtaining the sensor image and an operation of selecting the mapping information to be applied to the external display device 200 may be independently performed. Accordingly, the sensor image obtaining operation and the mapping information selecting operation may be simultaneously performed.

Meanwhile, when the mapping information to be applied to the external output preview image is selected, the controller 160 may generate the external output preview image based on the selected mapping information in operation 611. An operation of generating the external output preview image based on the selected mapping information may be an operation of converting the sensor image of the sensor Bayer pattern in accordance with the Bayer pattern of the external display device as described in FIG. 3.

Next, the controller 160 may transmit the external output preview image to the external display device 200 through the access interface 130 in operation 613. The controller 160 may repeatedly perform processes before operation 615 in which an input signal for terminating the preview mode is generated.

As described above, according to the image processing method and system and the electronic device supporting the same according to the embodiment of the present disclosure, the present disclosure may generate the preview image from the sensor image obtained by the image sensor 110 through a simpler procedure. Accordingly, the present disclosure may make a hardware device for processing the sensor image simpler, and accordingly, may secure a physical space. Further, the present disclosure may improve an operation efficiency of the electronic device by reducing a load of the sensor image processing.

According to an embodiment of the present disclosure, the Bayer pattern of the image obtained by the image sensor 110 supporting the preview mode is not limited to the aforementioned RGB/RGBW pattern. For example, the Bayer pattern may have more various forms according to a design scheme of the image sensor 110 or a change in the form.

According to an embodiment of the present disclosure, the image sensor 110 may generate the preview image by directly processing the subject image and transmit the preview image to the controller 160. The image sensor 110 may include an image processing module to process the image. For example, the configuration of the pre-processor 161, the mapping unit 163, and the post-processor 165 of the controller 160 may be included in the configuration of the image sensor 110. In this event, the image sensor 110 may be construed as the same meaning of an integrated module including all the aforementioned components. The mapping unit 163 included in the image sensor 110 having the configuration may mount the mapping information in an embedded type or a middleware type. Further, the image sensor 110 may generate the preview image based on the corresponding mapping information and transmit the preview image to the controller 160. The controller 160 may control only a function of outputting the preview image provided by the image sensor 110 on the display unit 140 without a separate operation of processing the preview image.

According to an embodiment of the present disclosure, the terminal 100 may further include various additional modules according to a provision form thereof. For example, the terminal 100 may further include components which have not been mentioned in the above description, such as an interface for transmitting and receiving data by a wired communication scheme or a wireless communication scheme and an Internet communication module communicating with an Internet network to perform an Internet function. These components may be variously modified according to the convergence trend of digital devices, and cannot be all enumerated. However, the electronic device may further include elements equivalent to the above-described elements. Also, it goes without saying that, in the terminal 100, particular components may be excluded from the above-described configuration or may be replaced with other components according to a provision form thereof. This may be easily understood by those skilled in the art to which the present disclosure pertains.

Also, examples of the electronic device according to various embodiments of the present disclosure may include all types of information communication devices, all types of multimedia devices, and application devices for all types of the information communication devices and all types of the multimedia devices, such as all mobile communication terminals operating based on communication protocols matched to various communication systems, a Portable Multimedia Player (PMP), a digital broadcast player, a Personal Digital Assistant (PDA), a music player (e.g., an MP3 player), a portable game console, a smart phone, a laptop computer, a handheld PC, and the like.

Various aspects of the present disclosure may also be embodied as computer readable code on a non-transitory computer readable recording medium. A non-transitory computer readable recording medium is any data storage device that may store data which may be thereafter read by a computer system. Examples of the non-transitory computer readable recording medium include Read-Only Memory (ROM), Random-Access Memory (RAM), CD-ROMs, magnetic tapes, floppy disks, and optical data storage devices. The non-transitory computer readable recording medium may also be distributed over network coupled computer systems so that the computer readable code is stored and executed in a distributed fashion. Also, functional programs, code, and code segments for accomplishing the present disclosure may be easily construed by programmers skilled in the art to which the present disclosure pertains.

At this point it should be noted that various embodiments of the present disclosure as described above typically involve the processing of input data and the generation of output data to some extent. This input data processing and output data generation may be implemented in hardware or software in combination with hardware. For example, specific electronic components may be employed in a mobile device or similar or related circuitry for implementing the functions associated with the various embodiments of the present disclosure as described above. Alternatively, one or more processors operating in accordance with stored instructions may implement the functions associated with the various embodiments of the present disclosure as described above. If such is the case, it is within the scope of the present disclosure that such instructions may be stored on one or more non-transitory processor readable mediums. Examples of the processor readable mediums include Read-Only Memory (ROM), Random-Access Memory (RAM), CD-ROMs, magnetic tapes, floppy disks, and optical data storage devices. The processor readable mediums may also be distributed over network coupled computer systems so that the instructions are stored and executed in a distributed fashion. Also, functional computer programs, instructions, and instruction segments for accomplishing the present disclosure may be easily construed by programmers skilled in the art to which the present disclosure pertains.

While the present disclosure has been shown and described with various embodiments thereof, it will be understood by those skilled in the art that various changes in form and details may be made therein without departing from the spirit and scope of the present disclosure as defined by the appended claims and their equivalents.

What is claimed is:

1. A method of processing an image by an electronic device, the method comprising:
obtaining a first image by using an image sensor;
generating a second image compatible with an output device from the first image based on mapping information; and
outputting the second image to the output device.

2. The method of claim 1, wherein the generating of the second image comprises mapping a Bayer pattern of the first image to a Bayer pattern of the output device based on the mapping information.

3. The method of claim 2, wherein the generating of the second image comprises:
down scale mapping the Bayer pattern of the first image to Bayer pattern of the output device; and
post-processing the down scale mapped image.

4. The method of claim 2, wherein the mapping of the Bayer pattern comprises mapping a color average of a plurality of subpixels included in the Bayer pattern of the first image to a color value of one subpixel of the output device.

5. The method of claim 2, wherein the mapping of the Bayer pattern comprises mapping a highest color value of a plurality of subpixels included in the Bayer pattern of the first image to a color value of one subpixel of the output device.

6. The method of claim 2, wherein the mapping of the Bayer pattern comprises applying a different mapping scheme according to a characteristic of each area of the first image.

7. The method of claim 6, wherein the mapping of the Bayer pattern comprises applying different down scaling schemes to a boundary area and a non-boundary area included in the first image.

8. The method of claim 1, wherein the generating of the second image comprises:
storing the first image in a memory;
identifying the mapping information; and
generating the second image from the first image based on the mapping information and storing the second image in the memory.

9. An electronic device comprising:
an image sensor configured to obtain a first image;
a storage unit configured to store at least one mapping information;
a display unit configured to selectively output a second image generated from the first image according to a control; and
a controller configured to generate the second image from the first image based on the mapping information, and to output the second image to the display unit.

10. The electronic device of claim 9, wherein the mapping information includes information in which a Bayer pattern of the first image is mapped to a Bayer pattern compatible with the display unit.

11. The electronic device of claim 9, further comprising:
an access interface to which at least one external display device is connected,
wherein the access interface comprises at least one of:
a wired communication interface connected to the at least one external display device through a wire; and
a wireless communication interface wirelessly connected to the at least one external display device.

12. The electronic device of claim 10, wherein the storage unit stores a mapping table including mapping information to be applied to each of a plurality of external display devices.

13. The electronic device of claim 12, wherein the controller collects identification information of an external display device of the plurality of external display devices connected to an access interface, searches for mapping information corresponding to the identification information, and generates an external output preview image to be output to the external display device.

14. The electronic device of claim 12, wherein the display unit automatically stops outputting the second image when an external display device of the plurality of external display devices is connected to the access interface.

15. The electronic device of claim 12, wherein the display unit outputs the second image independently from the output of an external output preview image of at least one connected external display device of the plurality of external display devices.

16. The electronic device of claim 10, further comprising:
a communication unit configured to receive updated mapping information.

17. The electronic device of claim 16, wherein the controller collects mapping information to be applied to an external display device from an external server device through the communication unit when the mapping information to be applied to the external display device does not exist in the electronic device.

18. The electronic device of claim 9, wherein the controller comprises:
a pre-processor configured to pre-process the first image obtained by the image sensor;
a mapping unit configured to perform a pattern conversion based on the mapping information;
a post-processor configured to post-process an image to which the pattern conversion is applied;
a memory configured to store the pre-processing, the pattern conversion, and the post-processing; and
a calculation unit configured to perform a calculation and a control for image processing.

19. An electronic device comprising:
an image obtaining module configured to obtain a first image by using an image sensor;
a generation module configured to generate a second image compatible with an output device from the first image based on mapping information; and
an output module configured to output the second image to the output device.

20. The electronic device of claim 19, further comprising:
a display unit configured to output a preview image generated from the first image based on mapping information corresponding to a Bayer pattern of the display unit.

21. A non-transitory computer-readable storage medium storing instructions that, when executed, cause at least one processor to perform the method of claim 1.
